(19) United States
(12) Patent Application Publication
(10) Pub. No.: US 2025/0208541 A1
(43) Pub. Date: Jun. 26, 2025

(54) FIXING DEVICE AND IMAGE FORMING APPARATUS

(71) Applicant: FUJIFILM Business Innovation Corp., Tokyo (JP)

(72) Inventors: Hideki KUGE, Kanagawa (JP); Makoto OCHIAI, Kanagawa (JP); Takayuki YAMASHITA, Kanagawa (JP); Takayuki UKAWA, Kanagawa (JP); Yasushi NAGATA, Kanagawa (JP)

(73) Assignee: FUJIFILM Business Innovation Corp., Tokyo (JP)

(21) Appl. No.: 18/747,468

(22) Filed: Jun. 19, 2024

(30) Foreign Application Priority Data
Dec. 25, 2023 (JP) 2023-218167

(51) Int. Cl. G03G 15/20

(52) U.S. Cl. CPC G03G 15/2028; G03G 15/2064; G03G 2215/2032

(57) ABSTRACT

A fixing device includes a first pressing unit, a second pressing unit that is movable between a contact position and a separation position with respect to the first pressing unit and that sandwiches a recording material, on which an unfixed image is formed, together with the first pressing unit at the contact position to heat and press the unfixed image, and a disposition unit that disposes the recording material on the first pressing unit in a state where the second pressing unit is positioned at the separation position.

### CROSS-REFERENCE TO RELATED APPLICATIONS

This application is based on and claims priority under 35 USC 119 from Japanese Patent Application No. 2023-218167 filed Dec. 25, 2023.

### BACKGROUND

### (i) Technical Field

The present invention relates to a fixing device and an image forming apparatus.

### (ii) Related Art

Disclosed in JP2016-136241A is a pressure device that applies a pressure to a sheet-shaped medium with an unfixed image formed on a portion of a surface of the sheet-shaped medium, the pressure device including a first pressing unit and a second pressing unit that are able to approach each other and to be separated from each other and of which at least one rotates with the sheet-shaped medium sandwiched between the pressing units to feed the sheet-shaped medium while applying a pressure to the sheet-shaped medium, a control unit that controls a driving unit such that a distance between the first pressing unit and the second pressing unit is made equal to a set target value, and a target setting unit that sets the target value. The target setting unit sets a first distance, which is greater than the thickness of the sheet-shaped medium, as the target value in a case where the sheet-shaped medium is not present between the first pressing unit and the second pressing unit and sets a second distance, at which a target pressure is applied to the sheet-shaped medium, as the target value in a case where the sheet-shaped medium and the unfixed image are present between the first pressing unit and the second pressing unit.

### SUMMARY

There is a fixing device including two pressing units movable between a contact position and a separation position, in which at least one of the pressing units is heated and a recording material with an unfixed image formed thereon is sandwiched between the pressing units. The recording material with the unfixed image formed thereon is pressed while being heated by the two pressing units. In this fixing device, in a case where the recording material comes into contact with the heated pressing units before the two pressing units press the recording material, the recording material is heated and contracts, which may cause paper wrinkles in the recording material.

Aspects of non-limiting embodiments of the present disclosure relate to a fixing device and an image forming apparatus that suppress deformation of the recording material that occurs in a case where the recording material comes into contact with the heated pressing units before the two pressing units press the recording material

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including a first pressing unit, a second pressing unit that is movable between a contact position and a separation position with respect to the first pressing unit and that sandwiches a recording material, on which an unfixed image is formed, together with the first pressing unit at the contact position to heat and press the unfixed image, and a disposition unit that disposes the recording material on the first pressing unit in a state where the second pressing unit is positioned at the separation position.

### BRIEF DESCRIPTION OF THE DRAWINGS

Exemplary embodiment(s) of the present invention will be described in detail based on the following figures, wherein:

FIG. 1 is a view showing an image forming apparatus to which a first exemplary embodiment is applied;

FIG. 2 is a perspective view showing the configurations of a transfer cylinder and a grasping unit;

FIG. 3 is a perspective view showing the configuration of a pressing cylinder;

FIG. 4 is a perspective view showing a state where the grasping unit grasps a recording material;

FIG. 5 is a view showing the configuration of a position changing unit;

FIG. 6 is a view showing a state where the heating roll is moved to the contact position due to the operation of the position changing unit;

FIG. 7A is a view showing a state where the recording material is transported toward a sandwiching region, and FIG. 7B is a view showing a state where the grasping unit is in a recess portion;

FIG. 8A is a view showing a state where the recording material is disposed at the sandwiching region, and FIG. 8B is a view showing a state where fixation on the recording material is started by the pressing cylinder and the heating roll;

FIG. 9 is an enlarged view of a region IX in FIG. 5 and is a view showing a positional relationship between a corner portion and grippers; and

FIG. 10 is a perspective view showing a pressing cylinder of a second exemplary embodiment.

### DETAILED DESCRIPTION

### Image Forming Apparatus 1

Hereinafter, an image forming apparatus to which a first exemplary embodiment is applied will be described in detail with reference to the accompanying drawings.

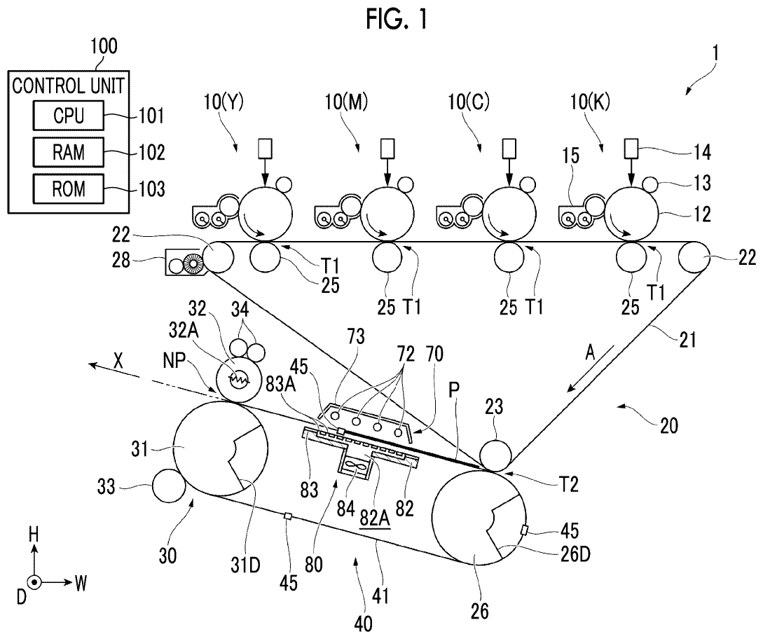

FIG. 1 is a view showing an image forming apparatus 1 to which a first exemplary embodiment is applied. The image forming apparatus 1 shown in FIG. 1 forms a text or images on a recording material P. Examples of the image forming apparatus 1 include an electrophotographic image forming apparatus that forms a toner image on the recording material P. Note that in each drawing, an arrow H indicates a vertical direction that is an apparatus up-down direction, an arrow W indicates a horizontal direction that is an apparatus width direction, and an arrow D indicates an apparatus front-rear direction (an apparatus depth direction).

The image forming apparatus 1 includes image forming units 10 (Y), 10 (M), 10 (C), and 10 (K) that form toner images, a transfer unit 20 that transfers the toner images formed by the image forming units 10 onto the recording material P, a fixation unit 30 that is an example of a fixing device fixing an unfixed toner image, which is an unfixed image, onto the recording material P, a transport unit 40 that transports the recording material P, and a control unit 100 that controls each unit of the image forming apparatus 1.

### Control Unit 100

The control unit 100 includes a central processing unit (CPU) 101 that controls the entire image forming apparatus 1, a random access memory (RAM) 102 that is used as a work area in the case of calculation, and a read only memory (ROM) 103 that is a memory storing various programs executed by the CPU 101, various settings, and the like.

### Image Forming Units 10

A plurality of the image forming units 10 shown in FIG. 1 are provided to form toner images of respective colors. In the present exemplary embodiment, the image forming units 10 for a total of four colors which are yellow (Y), magenta (M), cyan (C), and black (K) are provided. (Y), (M), (C), and (K) shown in FIG. 1 indicate constituent parts corresponding to the respective colors. Note that the image forming units 10 for the respective colors have the same configuration as each other except for a toner to be used. Therefore, in FIG. 1, each part of the image forming unit 10 (K), which serves as a representative of the image forming units 10 for the respective colors, is shown with a reference numeral given thereto.

Each of the image forming units 10 for the respective colors includes a photoconductor drum 12 onto which an electrostatic latent image is formed while the photoconductor drum 12 is rotating in a counterclockwise direction in FIG. 1. In addition, each of the image forming units 10 for the respective colors includes a charger 13 that charges a surface of the photoconductor drum 12, an exposure device 14 that causes the photoconductor drum 12 to be exposed to light, and a development device 15 that performs development of an electrostatic latent image formed on the photoconductor drum 12.

### Transfer Unit 20

The transfer unit 20 shown in FIG. 1 is a device that transfers a toner image formed by each image forming unit 10 to the recording material P.

The transfer unit 20 includes an intermediate transfer belt 21 on which toner images of respective colors formed on the respective photoconductor drums 12 of the image forming units 10 are transferred, and rolls 22 provided on an inner peripheral side of the intermediate transfer belt 21. In addition, the transfer unit 20 includes primary transfer rolls 25 that transfer the toner images of the respective colors of the image forming units 10 to the intermediate transfer belt 21 at primary transfer positions T1, and a facing roll 23 and a transfer cylinder 26 that collectively transfer, to the recording material P at a secondary transfer position T2, the toner images transferred onto the intermediate transfer belt 21. Furthermore, the transfer unit 20 includes a cleaner 28 that removes a toner or the like from a surface of the intermediate transfer belt 21.

The toner images are transferred to an outer peripheral surface of the intermediate transfer belt 21 from the photoconductor drums 12 for the respective colors.

As shown in FIG. 1, the intermediate transfer belt 21 has an endless shape and is wound around a plurality of the rolls 22 and the facing roll 23 such that the intermediate transfer belt 21 has an inverted triangular shape as seen in a front view (as seen in the apparatus depth direction). The intermediate transfer belt 21 revolves in a direction along an arrow A as at least one of the plurality of rolls 22 is rotationally driven.

In the present exemplary embodiment, a primary transfer electric field is applied between the primary transfer rolls 25 and the photoconductor drums 12, so that the toner images formed on the photoconductor drums 12 are transferred to the intermediate transfer belt 21 at the primary transfer positions T1.

The transfer cylinder 26 is disposed to face the facing roll 23 with the intermediate transfer belt 21 interposed therebetween. The transfer cylinder 26 is provided with a recess portion 26D for accommodation of a grasping unit 45 that grasps the recording material P.

As shown in FIG. 1, the cleaner 28 is disposed on an outer peripheral side of the intermediate transfer belt 21. In a revolution direction of the intermediate transfer belt 21, the cleaner 28 is disposed downstream of the secondary transfer position T2 and is disposed upstream of the image forming units 10.

### Fixation Unit 30

The fixation unit 30 shown in FIG. 1 includes a pressing cylinder 31 and a heating roll 32, and fixes an unfixed image formed on the recording material P by causing the recording material P to be sandwiched between the pressing cylinder 31 and the heating roll 32. The fixation unit 30 according to the present exemplary embodiment fixes an unfixed image on the recording material P by pressing the recording material P while heating the recording material P with two pressing units (a first pressing unit and a second pressing unit). The pressing cylinder 31 is an example of the first pressing unit, and the heating roll 32 is an example of the second pressing unit. In addition, the fixation unit 30 includes a first driving unit 33 that rotationally drives the pressing cylinder 31 and second driving units 34 that rotationally drive the heating roll 32. Furthermore, the fixation unit 30 includes a heating unit 70 that heats the recording material P before the pressing cylinder 31 and the heating roll 32 sandwich the recording material P.

The pressing cylinder 31 has an approximately roll-like shape that extends with an axial direction thereof being parallel to the apparatus front-rear direction. The pressing cylinder 31 is provided with a recess portion 31D for accommodation of the grasping unit 45.

The heating roll 32 is movable between a contact position and a separation position with respect to the pressing cylinder 31 and the heating roll 32 sandwiches the recording material P, on which the unfixed image has been formed, together with the pressing cylinder 31 at the contact position to heat the unfixed image and to press the unfixed image against the recording material P. Note that an operation of moving between the contact position and the separation position will be described later. The heating roll 32 has a roll-like shape that extends with an axial direction thereof being parallel to the apparatus front-rear direction. In addition, the heating roll 32 includes a heating source 32A, such as a halogen lamp, inside the roll.

As shown in FIG. 1, the pressing cylinder 31 and the heating roll 32 are disposed in an up-down direction that forms an angle with respect to the vertical direction. In addition, in FIG. 1, a sandwiching region in which the pressing cylinder 31 and the heating roll 32 sandwich the recording material P is represented by a reference numeral “NP”. Since the pressing cylinder 31 and the heating roll 32 come into contact with each other over a wide area due to the elastic force of the heating roll 32, the sandwiching region NP is a region wide in a transport direction of the recording material P.

The first driving unit 33 transmits power from a power source (not shown) to the pressing cylinder 31 to rotate the pressing cylinder 31. In the present exemplary embodiment, for example, an electric motor is used as the power source of the first driving unit 33. The first driving unit 33 is controlled by means of the turning on/off of the electric motor, and the electric motor is turned on in a case where the pressing cylinder 31 is to be rotationally driven. In addition, the electric motor is turned off in a case where the pressing cylinder 31 is being rotationally driven by the first driving unit 33 and the pressing cylinder 31 is to stop to be rotationally driven by the first driving unit 33.

The second driving units 34 transmit power from a power source (not shown) to the heating roll 32 to rotate the heating roll 32. In the present exemplary embodiment, for example, an electric motor is used as the power source of the second driving units 34. The second driving units 34 are controlled by means of the turning on/off of the electric motor, and the electric motor is turned on in a case where the heating roll 32 is to be rotationally driven. In addition, the electric motor is turned off in a case where the heating roll 32 is being rotationally driven by the second driving units 34 and the heating roll 32 is to stop to be rotationally driven by the second driving units 34.

In the present exemplary embodiment, the first driving unit 33 and the second driving units 34 have different power sources, and the first driving unit 33 and the second driving units 34 are individually controlled.

### Heating Unit 70

The heating unit 70 includes heaters 72 and a reflection plate 73, and heats the recording material P in a non-contact manner. The recording material P is transported in a transport direction X by the transport unit 40 and the heating unit 70 is disposed upstream of the sandwiching region NP in the transport direction X. Accordingly, an unfixed toner image formed on a front surface of the recording material P is heated by the heating unit 70 in a non-contact manner before the unfixed toner image is heated in the sandwiching region NP while being pressed.

As shown in FIG. 1, a plurality of the heaters 72 of the heating unit 70 are disposed at intervals along the transport direction X. Each heater 72 is composed of, for example, a columnar infrared heater extending in the apparatus front-rear direction. Regarding the heaters 72, filaments (not shown) provided in the heaters 72 generate heat and the recording material P is heated by radiant heat thereof. In the present exemplary embodiment, a plurality of the heaters 72 (four heaters in FIG. 1) are provided, and heating is performed by the plurality of heaters 72.

The reflection plate 73 has a function of reflecting infrared rays from the heaters 72 toward the recording material P. Specifically, the reflection plate 73 is formed in a box-like shape that is open on an apparatus lower side. The reflection plate 73 is formed by using, for example, a metal plate such as an aluminum plate.

### Transport Unit 40

The transport unit 40 transports the recording material P such that the recording material P passes through the secondary transfer position T2 and the sandwiching region NP. The transport unit 40 includes a pair of chains 41 that is wound around the transfer cylinder 26 and the pressing cylinder 31 and that is provided on an apparatus front side and an apparatus rear side and the grasping units 45 that are attached over the pair of chains 41 and that grasp a leading end of the recording material P. In addition, the transport unit 40 includes an air blowing unit 80.

Each of the pair of chains 41 is formed in an annular shape. One of the pair of chains 41 is wound around a front end portion of the transfer cylinder 26 in the apparatus front-rear direction and a front end portion of the pressing cylinder 31 in the apparatus front-rear direction. In addition, the other of the pair of chains 41 is wound around a rear end portion of the transfer cylinder 26 in the apparatus front-rear direction and a rear end portion of the pressing cylinder 31 in the apparatus front-rear direction.

The grasping units 45 are attached over the pair of chains 41 and revolve as the pair of chains 41 revolves. A plurality of the grasping units 45 are attached to the pair of chains 41. In the present exemplary embodiment, three grasping units 45 are attached.

### Air Blowing Unit 80

The air blowing unit 80 shown in FIG. 1 faces the heating unit 70 on a side (that is, a lower side in an H direction) opposite to the heating unit 70 side (that is, an upper side in the H direction) with respect to the recording material P transported by the grasping unit 45.

The air blowing unit 80 has a function of blowing air to the lower surface of the recording material P transported by the transport unit 40. The air blowing unit 80 has a function of blowing air to the recording material P to cause the recording material P to float such that the recording material P is transported by the transport unit 40 with a rear surface of the recording material P, which is opposite to the front surface on which the toner image is formed, being in a non-contact state and has a function of maintaining the non-contact state. In the present exemplary embodiment, the air blowing unit 80 includes a body 82, an air blowing plate 83, and an air blower 84. The body 82 includes an internal space 82A that is open upward.

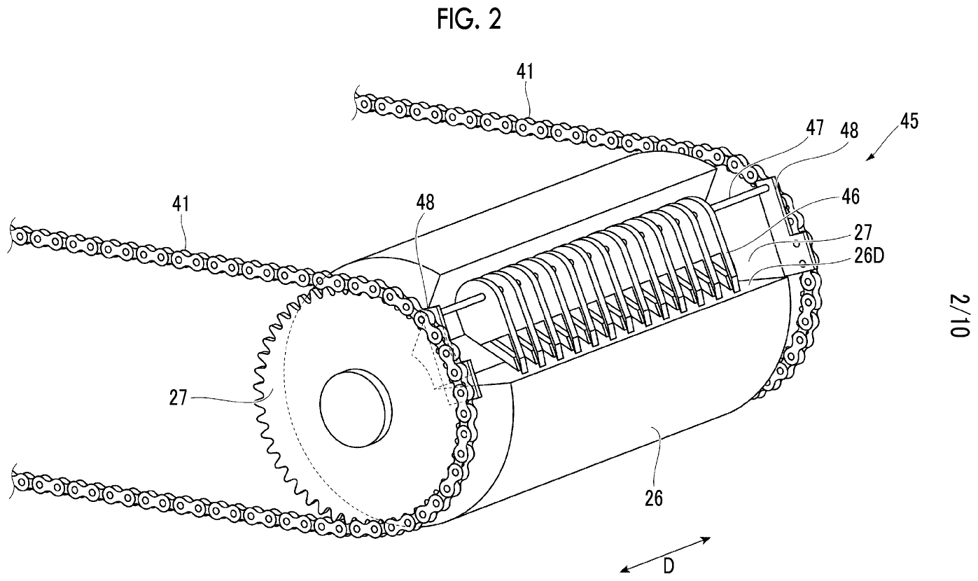

Next, the configuration of the transfer cylinder 26 and the grasping units 45 will be described in detail with reference to FIG. 2.

FIG. 2 is a perspective view showing the configurations of the transfer cylinder 26 and the grasping unit 45.

The transfer cylinder 26 is provided with first sprockets 27 that move the grasping units 45. A pair of the first sprockets 27 is provided at both ends of the transfer cylinder 26 in an axial direction and the pair of first sprockets 27 rotates integrally with the transfer cylinder 26. Each first sprocket 27 has a disk-like shape, and a plurality of teeth over which the chain 41 is looped are provided over an end portion of the disk-like shape. The pair of chains 41 is wound around the pair of first sprockets 27, respectively.

The recess portion 26D of the transfer cylinder 26 is a cutout portion having a size enough for accommodation of the grasping unit 45, and is open radially outward with respect to the transfer cylinder 26.

The grasping unit 45 is provided between the pair of chains 41 on the front side and the rear side, and the grasping unit 45 grasps and transports the recording material P. The grasping unit 45 includes a plurality of grippers 46 that hold a leading end of the recording material P, a support member 47 that supports the plurality of grippers 46, and attachment bases 48 through which the support member 47 is attached to the chains 41. The attachment base 48 is provided for each of the pair of chains 41 on the front side and the rear side.

Each gripper 46 is provided with a circular through-hole through which the support member 47 is inserted.

The support member 47 is a rod-shaped member having a circular cross section. In addition, the support member 47 is formed to have a length matching an interval between the pair of chains 41 on the front side and the rear side. The plurality of grippers 46 are fixed to the support member 47 at predetermined intervals.

The attachment bases 48 are positioned inward of the pair of chains 41 and respectively attached to links of the pair of chains 41 that face each other. One end of the support member 47 is attached to one attachment base 48, and the other end of the support member 47 with respect to the one end is attached to the other attachment base 48, so that the support member 47 is attached over the pair of chains 41.

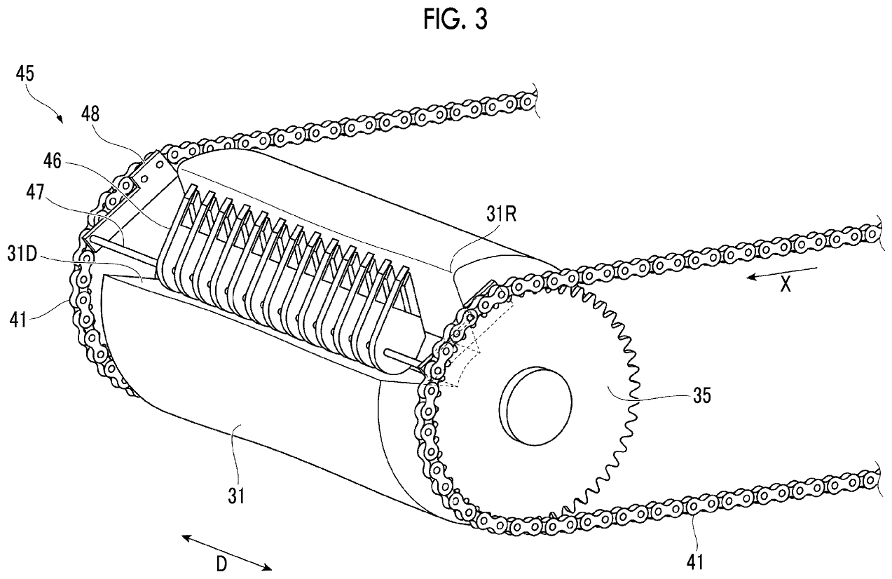

Next, the configuration of the pressing cylinder 31 will be described in detail with reference to FIG. 3.

FIG. 3 is a perspective view showing the configuration of the pressing cylinder 31.

Both ends of the pressing cylinder 31 in an axial direction are provided with second sprockets 35 that move the grasping units 45. The second sprockets 35 are disposed to be coaxial with the pressing cylinder 31 and the second sprockets 35 rotate integrally with the pressing cylinder 31. Each second sprocket 35 has a disk-like shape, and a plurality of teeth over which the chain 41 is looped are provided over an end portion of the disk-like shape. The pair of chains 41 is wound around the pair of second sprockets 35, respectively.

The recess portion 31D of the pressing cylinder 31 is a cutout portion having a size enough for accommodation of the grasping unit 45, and is open radially outward with respect to the pressing cylinder 31. In a case where the grasping unit 45 is accommodated in the recess portion 31D, the grasping unit 45 and the pressing cylinder 31 rotate integrally with each other. A corner portion 31R is formed at an upstream end of the recess portion 31D in a rotation direction. The corner portion 31R is formed in a rounded shape, that is, a so-called R shape.

In addition, the pressing cylinder 31 has a roll-like shape, and diameters of the roll-like shape on both end portion sides in an axial direction are larger than a diameter of a central portion in the axial direction. Accordingly, the circumferential speed on the end portion sides of the pressing cylinder 31 in the axial direction is higher than the circumferential speed of the central portion in the axial direction, and the recording material P pressed by the pressing cylinder 31 and the heating roll 32 is stretched to both end sides of the pressing cylinder 31, so that generation of wrinkles in the recording material P is suppressed.

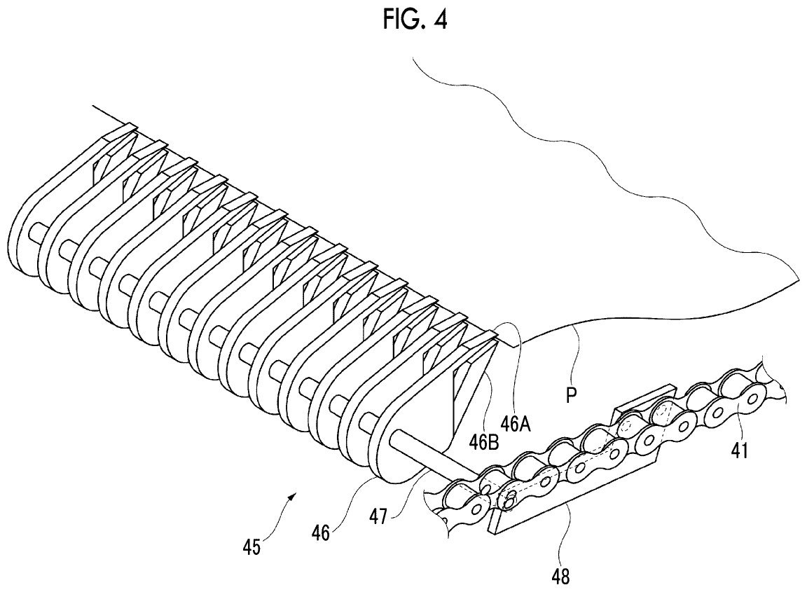

Next, a function of the grasping unit 45 that is for the grasping of the recording material P will be described with reference to FIG. 4.

FIG. 4 is a perspective view showing a state where the grasping unit 45 grasps the recording material P.

Each gripper 46 includes a claw 46A and a claw base 46B and grasps the recording material P by using the claw 46A and the claw base 46B. Note that, regarding the gripper 46, for example, the claw 46A is pressed against the claw base 46B by a spring or the like and the claw 46A is opened or closed with respect to the claw base 46B by the action of a cam or the like. The gripper 46 is disposed downstream of the recording material P in the transport direction, and holds a leading end portion of the recording material P at a position downstream of the recording material P in the transport direction.

### Position Changing Unit 90

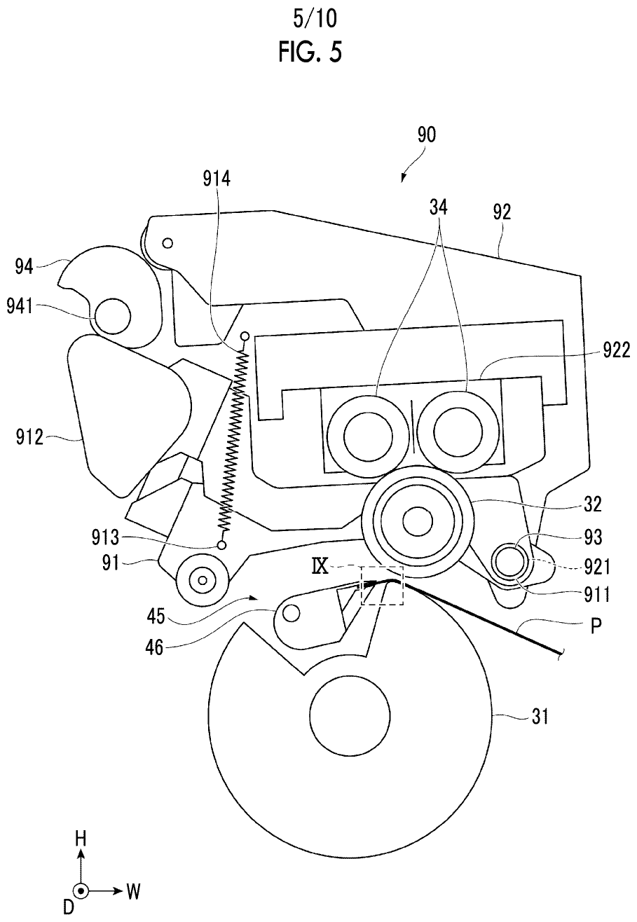

Here, the configuration of a position changing unit 90 that moves the heating roll 32 to the contact position and the separation position will be described with reference to FIG. 5.

FIG. 5 is a view showing the configuration of the position changing unit 90. Note that in FIG. 5, a state where the heating roll 32 is moved to the separation position due to the operation of the position changing unit 90 is shown. At the separation position, the heating roll 32 is separated from the pressing cylinder 31. For example, in a case where the grasping unit 45 passes through a space between the pressing cylinder 31 and the heating roll 32, the heating roll 32 is at the separation position. In addition, in the present exemplary embodiment, for example, in order to prevent generation of a load that is caused due to contact between the pressing cylinder 31 and the heating roll 32, the heating roll 32 is at the separation position in a case where the image forming apparatus 1 is in a standby state. Meanwhile, at the contact position, the heating roll 32 is in contact with the pressing cylinder 31. In a case where a toner image formed on the recording material P is to be fixed, a fixing operation is performed by the pressing cylinder 31 and the heating roll 32 with the heating roll 32 being at the contact position.

The position changing unit 90 supports the heating roll 32 and moves the heating roll 32 to the contact position and the separation position. The position changing unit 90 includes a lower frame 91 that supports the heating roll 32, an upper frame 92 that supports a plurality of the second driving units 34, a connection shaft 93 that connects the lower frame 91 and the upper frame 92 to each other, and a cam 94 that changes the position of the heating roll 32 through the lower frame 91.

The lower frame 91 extends in a W direction which is the apparatus width direction, and a rotation center hole 911, which is the center of rotation of the lower frame 91, is provided at one end of the lower frame 91 in a width direction. In addition, the other end of the lower frame 91 in the width direction is provided with a cam follower 912 that comes into contact with the cam 94, a spring attachment portion 913 for attachment of a spring, and a tension coil spring 914 that is attached to the spring attachment portion 913. In addition, the lower frame 91 rotatably supports the heating roll 32 on the rotation center hole 911 side in the width direction.

The rotation center hole 911 is a circular through-hole, and the connection shaft 93 is inserted into the through-hole. The rotation center hole 911 and the connection shaft 93 are not fixed and attachment is performed such that the rotation center hole 911 is made rotatable around the connection shaft 93.

The cam follower 912 is fixed to an end portion of the lower frame 91 and comes into contact with an outer circumference of the cam 94. In a case where the cam 94 is rotated, the cam follower 912 is moved around the rotation center hole 911 to match the movement of the outer circumference of the cam 94.

The spring attachment portion 913 is, for example, a columnar protrusion, and one end of the tension coil spring 914 is fixed by being wound around the spring attachment portion 913.

Regarding the tension coil spring 914, the other end of the tension coil spring 914 with respect to the one end attached to the spring attachment portion 913 is attached at a position above the position of the spring attachment portion 913 in the H direction. The tension coil spring 914 is attached in a state of being stretched such that the length thereof is made larger than the natural length of the spring. That is, the tension coil spring 914 is attached to pull up the spring attachment portion 913 upward.

The upper frame 92 includes a rotation center hole 921, which is the center of rotation of the upper frame 92, and a support portion 922 that supports the second driving units 34.

The rotation center hole 921 is a circular through-hole, and the connection shaft 93 is inserted into the through-hole. The rotation center hole 921 and the connection shaft 93 are not fixed and attachment is performed such that the rotation center hole 921 is made rotatable around the connection shaft 93.

The support portion 922 supports the second driving units 34 such that each of the second driving units 34 comes into contact with an upper portion of the heating roll 32.

The cam 94 includes a cam driving unit 941 that rotates the cam 94. The cam driving unit 941 is provided to be able to rotationally drive the cam 94 in a clockwise direction and a counterclockwise direction in FIG. 5. The cam driving unit 941 rotates clockwise and counterclockwise to control the angle of the cam 94. As the cam driving unit 941, for example, a servo motor is used. The outer circumference of the cam 94 has a plurality of portions that are different from each other in diameter from the center of rotation of the cam driving unit 941.

### About Operation of Position Changing Unit 90

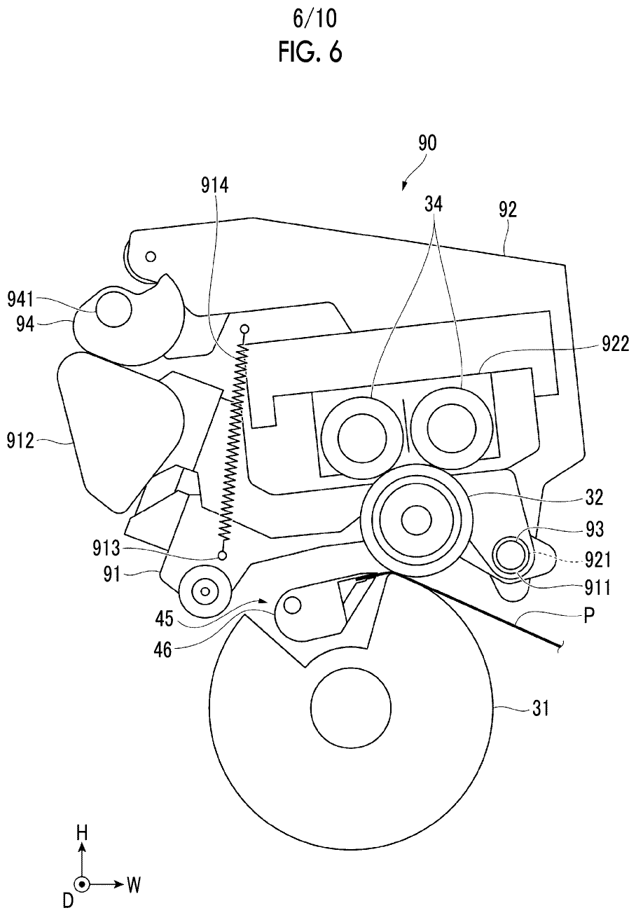

Next, the operation of the position changing unit 90 will be described with reference to FIGS. 5 and 6.

FIG. 6 is a view showing a state where the heating roll 32 is moved to the contact position due to the operation of the position changing unit 90.

In FIG. 5 described above, the recording material P transported to the sandwiching region NP (refer to FIG. 1) by the grasping unit 45 is shown. In a case where the cam 94 is rotated in the clockwise direction in FIG. 5 in a state as shown in FIG. 5, the position of contact between the cam follower 912 and the cam 94 changes, so that a large-diameter portion of the cam 94 and the cam follower 912 are brought into contact with each other as shown in FIG. 6. Since the large-diameter portion of the cam 94 presses the cam follower 912 downward, the lower frame 91 is rotated counterclockwise around the rotation center hole 911 by pressing. Accordingly, the position changing unit 90 moves the heating roll 32 from the separation position to the contact position.

In addition, in a case where the cam 94 is rotated in a counterclockwise direction in FIG. 6 in a state as shown in FIG. 6, the position of contact between the cam follower 912 and the cam 94 changes, so that a short-diameter portion of the cam 94 and the cam follower 912 are brought into contact with each other as shown in FIG. 5. Accordingly, the position changing unit 90 moves the heating roll 32 from the contact position to the separation position.

In addition, in a case where the cam 94 is further rotated in the clockwise direction in a state where the heating roll 32 is at the contact position (that is, in a state as shown in FIG. 6), the cam follower 912 is further pressed downward. The heating roll 32 is pressed against the pressing cylinder 31 and a pressure between the heating roll 32 and the pressing cylinder 31 is increased. It is possible to change a pressure applied to the recording material P by controlling the cam driving unit 941. Accordingly, for example, it is possible to change the degree of a pressure to be applied in accordance with the type of paper.

### About Fixing Operation

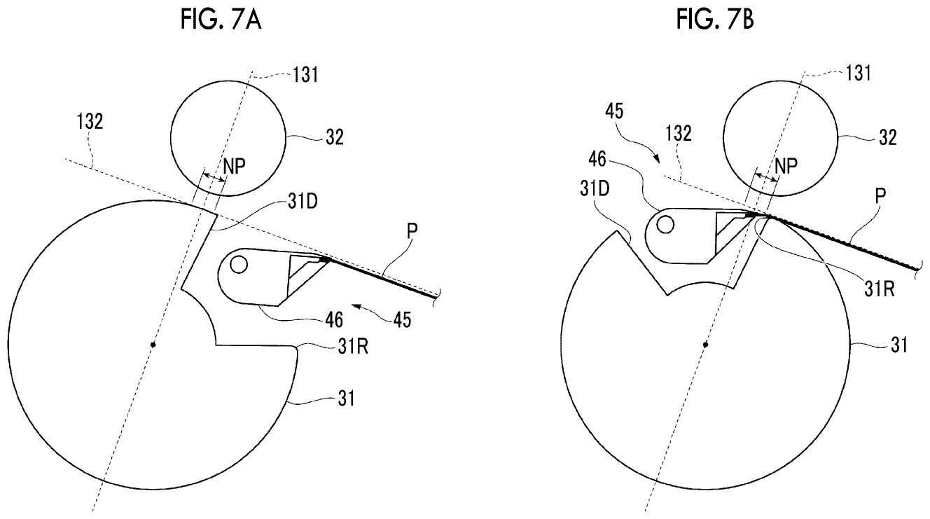

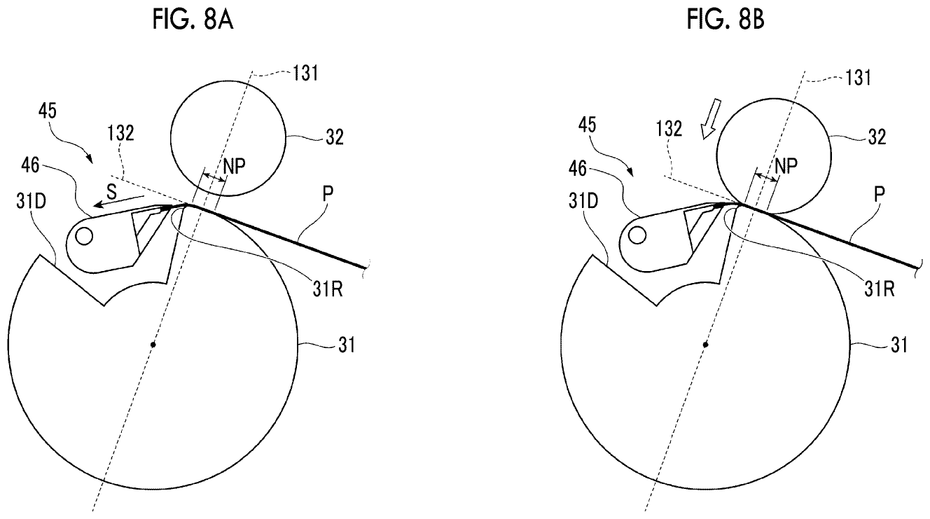

Next, a fixing operation will be described with reference to FIGS. 7A, 7B, 8A, and 8B.

FIG. 7A is a view showing a state where the recording material P is transported toward the sandwiching region NP, and FIG. 7B is a view showing a state where the grasping unit 45 is in the recess portion 31D.

FIG. 8A is a view showing a state where the recording material P is disposed at the sandwiching region NP due to the grippers 46, and FIG. 8B is a view showing a state where fixation on the recording material P is started by the pressing cylinder 31 and the heating roll 32.

In FIGS. 7A and 7B, and FIGS. 8A and 8B, a center line 131, which is a line connecting the center of the pressing cylinder 31 and the center of the heating roll 32, is represented by a dotted line. In addition, a tangent line 132 at a position where the pressing cylinder 31 and the heating roll 32 come into contact with each other first in the case of the start of fixation is represented by a dotted line.

As shown in FIG. 7A, in a case where the recording material P is transported to the sandwiching region NP, the heating roll 32 is positioned at the separation position.

The grippers 46 of the grasping unit 45 grasp a downstream end portion of the recording material P in the transport direction and move toward the sandwiching region NP. The positions of distal ends of the grippers 46 are below the tangent line 132. In other words, the distal ends of the grippers 46 are positioned on the pressing cylinder 31 side with respect to the tangent line 132 instead of being positioned on the heating roll 32 side. In addition, the recording material P is positioned on the pressing cylinder 31 side with respect to the tangent line 132.

The pressing cylinder 31 rotates in a counterclockwise direction in FIG. 7A with the grasping unit 45 accommodated in the recess portion 31D.

FIG. 7B shows a state after rotation of the pressing cylinder 31 in a state as shown in FIG. 7A, in which the grasping unit 45 is in the recess portion 31D. Specifically, FIG. 7B shows a state where links of the chain 41 (refer to FIG. 3) that are provided with the attachment bases 48 (refer to FIG. 3) of the grasping unit 45 are engaged with teeth of the second sprockets 35 (refer to FIG. 3). Therefore, in a case where the pressing cylinder 31 in a state as shown in FIG. 7B is further rotated, the grasping unit 45 and the recess portion 31D are rotated integrally with each other. That is, rotation is performed without changing the positional relationship between the grasping unit 45 and the recess portion 31D.

In a state where the grasping unit 45 is in the recess portion 31D as shown in FIG. 7B, the recording material P grasped by the grippers 46 is in contact with the corner portion 31R of the pressing cylinder 31. In a state as shown in FIG. 7B, the grippers 46 are disposed radially inward of the outer circumference of the pressing cylinder 31. In addition, the distal ends of the gripper 46 that grasp the recording material P are positioned radially inward of the outer circumference of the pressing cylinder 31.

In addition, the recording material P is positioned on the pressing cylinder 31 side with respect to the tangent line 132.

In addition, in FIG. 7B, the grippers 46 press the recording material P against the corner portion 31R and restrain the recording material P from approaching the heating roll 32 side.

In FIG. 8A, the pressing cylinder 31 in the state as shown in FIG. 7B has been further rotated in a counterclockwise direction in the drawing.

In FIG. 8A, the grippers 46 are disposed to press the recording material P against the pressing cylinder 31 in a state where the heating roll 32 is positioned at the separation position.

Regarding the grippers 46, the grippers 46 are accommodated into the recess portion 31D provided at the pressing cylinder 31 in a state where the heating roll 32 is positioned at the separation position so that the recording material P is grasped and drawn to the sandwiching region NP. Furthermore, a direction that the leading end of the recording material P grasped by the grippers 46 faces in a state where the grippers 46 are accommodated in the recess portion 31D is represented by an arrow S. The grippers 46 grasp the recording material P such that the leading end of the recording material P faces a position inward of the outer circumference of the pressing cylinder 31 in the radial direction of the pressing cylinder 31. Accordingly, the leading end portion of the recording material P is disposed close to an inner portion of the pressing cylinder 31 and thus the leading end portion of the recording material P is restrained from coming into contact with the heating roll 32 during transportation of the recording material P.

In FIG. 8B, the heating roll 32 in a state as shown in FIG. 8A has been moved to the contact position, and heating and pressing performed by the heating roll 32 and the pressing cylinder 31 are started. In FIG. 8A, the recording material P is in contact with the pressing cylinder 31 having a low temperature and the recording material P is separated from the heating roll 32 that is heated. In FIG. 8A, the recording material P is pressed against the pressing cylinder 31 and is in contact with the pressing cylinder 31. Since the heating roll 32 comes into contact with the recording material P for the first time in the case of the start of fixation, the recording material P is not heated before the fixation is started, so that generation of paper wrinkles caused by the heating of the recording material P is suppressed. Here, the “low temperature” means a temperature lower than the temperature of the heating roll 32. In the image forming apparatus 1 according to the present exemplary embodiment, the pressing cylinder 31 is not heated, and the temperature of the pressing cylinder 31 is approximately the same as the room temperature. Note that the pressing cylinder 31 may be heated to a temperature at which the recording material P in contact with the pressing cylinder 31 does not contract.

In addition, regarding the grasping unit 45, all or part of the plurality of grippers 46 may be slightly opened so that the recording material P is disposed along the pressing cylinder 31. Here, the expression “being slightly opened” means to provide a gap between the claws 46A and the claw bases 46B of the grippers 46 to such an extent that the position of the recording material P does not deviate in the transport direction of the recording material P.

### Positional Relationship between Corner Portion 31R and Distal Ends of Grippers 46

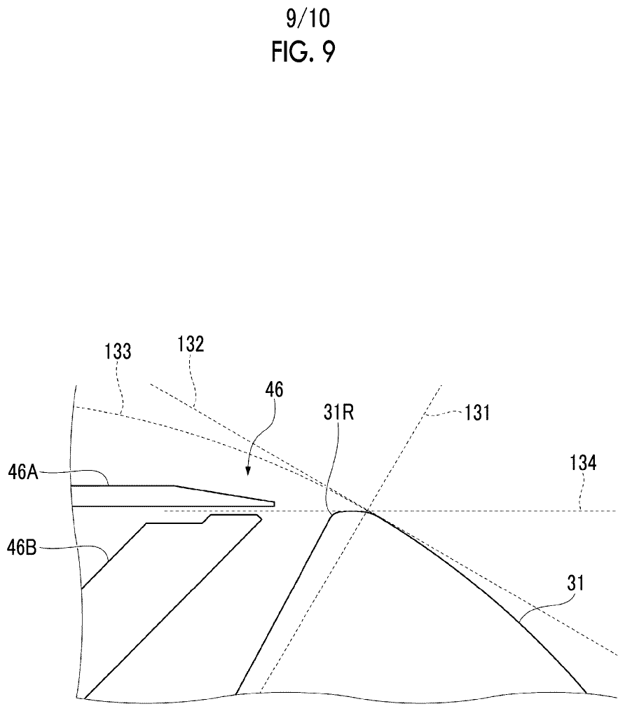

Next, a positional relationship between the corner portion 31R and the grippers 46 in the case of the start of fixation will be described with reference to FIG. 9.

FIG. 9 is an enlarged view of a region IX in FIG. 5 and is a view showing a positional relationship between the corner portion 31R and the grippers 46.

In FIG. 9, a distal end of the claw 46A of the gripper 46, a distal end of the claw base 46B of the gripper 46, and the corner portion 31R of the pressing cylinder 31 are represented by solid lines. In addition, in order to show the positional relationship between the claw 46A, the claw base 46B, and the corner portion 31R, an arc 133 showing the outer circumference of the pressing cylinder 31 and a grasping plane 134 showing an angle at which the recording material P is grasped are represented by broken lines in FIG. 9. In addition, in FIG. 9, the above-described center line 131 and the tangent line 132 are represented by broken lines.

The grasping plane 134 is a line showing a plane obtained by virtually extending a plane on which the claw 46A and the claw base 46B grasp the paper surface of the recording material P. As shown in FIG. 9, the corner portion 31R is positioned closer to the pressing cylinder 31 side than the tangent line 132 is. The grasping plane 134 is tangent to the corner portion 31R. Therefore, the recording material P grasped by the gripper 46 is disposed along the grasping plane 134 over an area from an end portion grasped by the gripper 46 to a portion that is in contact with the corner portion 31R. In other words, the gripper 46 disposes the recording material P on the corner portion 31R that is positioned closer to the pressing cylinder 31 side than the tangent line 132 is.

In addition, on a side downstream of the sandwiching region NP (refer to FIG. 8B) in the transport direction of the recording material P (that is, on the left side of the center line 131 in FIG. 9), the grasping plane 134 is positioned inward of the tangent line 132 in a radial direction of the pressing cylinder 31. Accordingly, for example, even in a case where the recording material P is hard paper, the recording material P grasped by the gripper 46 is restrained from moving toward the heating roll 32 side.

In addition, as shown in FIG. 9, the distal end of the claw 46A and the distal end of the claw base 46B that hold the recording material P are positioned inward of the arc 133 in the radial direction of the pressing cylinder 31. In addition, FIG. 9 shows that a point where the center line 131 and the grasping plane 134 intersect each other is positioned on the arc 133 showing the outer circumference of the pressing cylinder 31. In other words, in a state where the gripper 46 is accommodated in the recess portion 31D, the leading end portion of the recording material P grasped by the gripper 46 is positioned inward of the outer circumference of the pressing cylinder 31 in the radial direction of the pressing cylinder 31, and a point where the grasping plane 134 and the center line 131 intersect each other is positioned on the outer circumference of the pressing cylinder 31. Therefore, in a case where fixation is started in the sandwiching region NP, the recording material P disposed on the pressing cylinder 31 is positioned on an inner side in the radial direction of the pressing cylinder 31 over an area from the leading end of the recording material P to the sandwiching region NP, so that the recording material P is restrained from coming into contact with the heating roll 32.

In addition, in a state where the gripper 46 is accommodated in the recess portion 31D, the gripper 46 may grasp the recording material P such that the leading end portion of the recording material P grasped by the gripper 46 is positioned inward of the outer circumference of the pressing cylinder 31 in the radial direction of the pressing cylinder 31 and the point where the grasping plane 134 and the center line 131 intersect each other is positioned inward of the outer circumference of the pressing cylinder 31 in the radial direction of the pressing cylinder 31. Accordingly, the recording material P grasped by the gripper 46 is pressed against the pressing cylinder 31.

In the first exemplary embodiment, the gripper 46 disposes the recording material P on the pressing cylinder 31, so that the recording material P is brought into contact with the pressing cylinder 31 until pressing performed by the heating roll 32 is started.

### Second Exemplary Embodiment

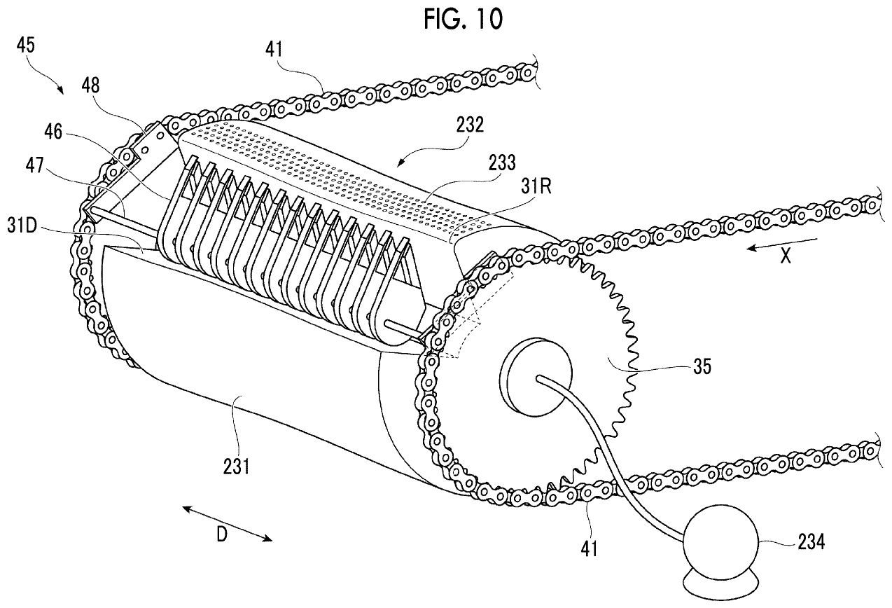

In the first exemplary embodiment, the recording material P is disposed on the pressing cylinder 31 by the gripper 46. However, a method of disposing the recording material P on the pressing cylinder 31 is not limited thereto. In a second exemplary embodiment, the recording material P is disposed on the pressing cylinder 231 by a sticking mechanism that sticks the recording material P. FIG. 10 is a perspective view showing a pressing cylinder 231 of the second exemplary embodiment. Note that the same functions as functions in the first exemplary embodiment will be given the same reference numerals and will not be described here.

The pressing cylinder 231 shown in FIG. 10 includes a sticking unit 232 that functions as another example of a disposition unit that attracts the recording material P to the pressing cylinder 231.

The sticking unit 232 includes sticking holes 233 for attraction of the recording material P and a vacuum pump 234 that makes the pressure of the inside of the pressing cylinder 231 negative.

The sticking holes 233 are connected to the vacuum pump 234 through the inside of the pressing cylinder 231 and the pressures thereof are set to a negative pressure by the vacuum pump 234. A plurality of the sticking holes 233 are provided at a peripheral surface of the pressing cylinder 231. In the present exemplary embodiment, the sticking holes 233 are provided only in a certain angular area from the corner portion 31R of the pressing cylinder 231 to a downstream side in a rotation direction of the pressing cylinder 231. The area in which the sticking holes 233 are provided is determined as a region that corresponds to the sandwiching region NP in a case where pressing with respect to the recording material P is started by the pressing cylinder 231 and the heating roll 32, for example.

The vacuum pump 234 sucks air inside the pressing cylinder 231 to make the pressure of the inside of the pressing cylinder 231 negative. The vacuum pump 234 is attached to a rotation shaft of the pressing cylinder 231 and sucks the air inside the pressing cylinder 231 through the rotation shaft.

### Operation of Vacuum Pump

In a case where the grasping unit 45 (refer to FIG. 7B) that transports the recording material P is accommodated in the recess portion 31D (refer to FIG. 7B), the vacuum pump 234 sucks the air inside the pressing cylinder 231 such that the recording material P is attracted. Then, until fixation on the recording material P is started by the pressing cylinder 231 and the heating roll 32 (refer to FIG. 8B), the vacuum pump 234 continues to suck the air. In a case where the fixation on the recording material P is started, the vacuum pump 234 stops to suck the air. Accordingly, the recording material P is restrained from floating in the sandwiching region NP and the recording material P is restrained from coming into contact with the heating roll 32 before the start of fixation.

In addition, since the recording material P is attracted to the pressing cylinder 231 due to a negative pressure and the recording material P is disposed in close contact with a surface of the pressing cylinder 231, generation of paper wrinkles caused in a case where the pressing cylinder 231 and the heating roll 32 press the recording material P is suppressed.

Note that in the second exemplary embodiment, the gripper 46 may have the same shape as the shape of the gripper 46 of the first exemplary embodiment or may have a shape different from the shape of the gripper 46 of the first exemplary embodiment. In addition, the gripper 46 and the sticking unit 232 may function as the disposition unit.

In addition, in the present exemplary embodiment, a sticking mechanism performs sticking in which suction is performed by means of a negative pressure. However, the sticking mechanism is not limited thereto. For example, a voltage may be applied to the pressing cylinder 231 so that the pressing cylinder 231 is charged and the recording material P is attracted due to electrostatic sticking. For example, in a case where a toner image formed on the recording material P is charged negatively, the pressing cylinder 231 is charged positively so that the recording material P is attracted to the pressing cylinder 231.

### Supplementary Note

(((1)))

A fixing device comprising:
a first pressing unit;
a second pressing unit that is movable between a contact position and a separation position with respect to the first pressing unit and that sandwiches a recording material, on which an unfixed image is formed, together with the first pressing unit at the contact position to heat and press the unfixed image; and
a disposition unit that disposes the recording material on the first pressing unit in a state where the second pressing unit is positioned at the separation position.
   (((2)))

The fixing device according to (((1))),
wherein the disposition unit disposes the recording material to be closer to a first pressing unit side than a tangent line is, the tangent line being a tangent line in a case of contact between the first pressing unit and the second pressing unit at the contact position.
   (((3)))

The fixing device according to (((2))),
wherein the disposition unit is a grasping unit that grasps a leading end portion of the recording material,
the grasping unit is accommodated into a recess portion provided at the first pressing unit in a state where the second pressing unit is positioned at the separation position so that the recording material is grasped and drawn to the contact position, and
the grasping unit grasps the recording material such that a leading end of the recording material grasped by the grasping unit faces a position inward of an outer circumference of the first pressing unit in a radial direction of the first pressing unit in a state where the grasping unit is accommodated in the recess portion.
   (((4)))

The fixing device according to (((3))),
wherein the grasping unit grasps the recording material such that a plane obtained by virtually extending a surface of a portion of the recording material grasped by the grasping unit is positioned radially inward of a tangent line at a position where the first pressing unit and the second pressing unit come into contact with each other when the first pressing unit and the second pressing unit are at contact positions at a time of fixation.
   (((5)))

The fixing device according to any one of (((1)) to 4))),
wherein the first pressing unit has a roll-like shape,
diameters of the roll-like shape on both end portion sides in an axial direction are larger than a diameter of a central portion in the axial direction, and
the grasping unit is slightly opened before fixation is started so that the recording material is disposed along the first pressing unit.
   (((6)))

The fixing device according to (((2))),
wherein the disposition unit attracts the recording material to the first pressing unit.
   (((7)))

The fixing device according to (((6))), wherein the disposition unit makes a pressure of an inside of the first pressing unit negative so that the recording material is attracted due to a negative pressure.

(((8)))

The fixing device according to (((6))),
wherein the disposition unit charges the first pressing unit so that the recording material is attracted due to electrostatic sticking.
   (((9)))

The fixing device according to (((1))),
wherein each of the first pressing unit and the second pressing unit has a roll-like shape,
the disposition unit is a grasping unit that grasps a leading end portion of the recording material,
the grasping unit is accommodated into a recess portion provided at the first pressing unit with the second pressing unit being positioned at the separation position so that the recording material is grasped and drawn to the contact position, and
in a state where the grasping unit is accommodated in the recess portion, the leading end portion of the recording material grasped by the grasping unit is positioned inward of an outer circumference of the first pressing unit in a radial direction of the first pressing unit, and a point where a plane obtained by virtually extending a grasped surface of the recording material and a line connecting a center of the first pressing unit to a center of the second pressing unit intersect each other is positioned on the outer circumference of the first pressing unit or positioned inward of the outer circumference of the first pressing unit in the radial direction.
   (((10)

An image forming apparatus comprising:
an image formation unit that forms an unfixed image on a recording material; and
the fixing device according to any one of (((1))) to (((9))) that fixes, onto the recording material, the unfixed image that is formed by the image formation unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a first pressing unit;
a second pressing unit that is movable between a contact position and a separation position with respect to the first pressing unit and that sandwiches a recording material, on which an unfixed image is formed, together with the first pressing unit at the contact position to heat and press the unfixed image; and
a disposition unit that disposes the recording material on the first pressing unit in a state where the second pressing unit is positioned at the separation position.

2. The fixing device according to claim 1,
wherein the disposition unit disposes the recording material to be closer to a first pressing unit side than a tangent line is, the tangent line being a tangent line in a case of contact between the first pressing unit and the second pressing unit at the contact position.

3. The fixing device according to claim 2,
wherein the disposition unit is a grasping unit that grasps a leading end portion of the recording material,
the grasping unit is accommodated into a recess portion provided at the first pressing unit in a state where the second pressing unit is positioned at the separation position so that the recording material is grasped and drawn to the contact position, and
the grasping unit grasps the recording material such that a leading end of the recording material grasped by the grasping unit faces a position inward of an outer circumference of the first pressing unit in a radial direction of the first pressing unit in a state where the grasping unit is accommodated in the recess portion.

4. The fixing device according to claim 3,
wherein the grasping unit grasps the recording material such that a plane obtained by virtually extending a surface of a portion of the recording material grasped by the grasping unit is positioned radially inward of a tangent line at a position where the first pressing unit and the second pressing unit come into contact with each other when the first pressing unit and the second pressing unit are at contact positions at a time of fixation.

5. The fixing device according to claim 4,
wherein the first pressing unit has a roll-like shape,
diameters of the roll-like shape on both end portion sides in an axial direction are larger than a diameter of a central portion in the axial direction, and
the grasping unit is slightly opened before fixation is started so that the recording material is disposed along the first pressing unit.

6. The fixing device according to claim 2,
wherein the disposition unit attracts the recording material to the first pressing unit.

7. The fixing device according to claim 6,
wherein the disposition unit makes a pressure of an inside of the first pressing unit negative so that the recording material is attracted due to a negative pressure.

8. The fixing device according to claim 6,
wherein the disposition unit charges the first pressing unit so that the recording material is attracted due to electrostatic sticking.

9. The fixing device according to claim 1,
wherein each of the first pressing unit and the second pressing unit has a roll-like shape, the disposition unit is a grasping unit that grasps a leading end portion of the recording material,
the grasping unit is accommodated into a recess portion provided at the first pressing unit with the second pressing unit being positioned at the separation position so that the recording material is grasped and drawn to the contact position, and
in a state where the grasping unit is accommodated in the recess portion, the leading end portion of the recording material grasped by the grasping unit is positioned inward of an outer circumference of the first pressing unit in a radial direction of the first pressing unit, and a point where a plane obtained by virtually extending a grasped surface of the recording material and a line connecting a center of the first pressing unit to a center of the second pressing unit intersect each other is positioned on the outer circumference of the first pressing unit or positioned inward of the outer circumference of the first pressing unit in the radial direction.

10. An image forming apparatus comprising:
an image formation unit that forms an unfixed image on a recording material; and
the fixing device according to claim 1 that fixes, onto the recording material, the unfixed image that is formed by the image formation unit.

11. An image forming apparatus comprising:
an image formation unit that forms an unfixed image on a recording material; and
the fixing device according to claim 2 that fixes, onto the recording material, the unfixed image that is formed by the image formation unit.

12. An image forming apparatus comprising:
an image formation unit that forms an unfixed image on a recording material; and
the fixing device according to claim 3 that fixes, onto the recording material, the unfixed image that is formed by the image formation unit.

13. An image forming apparatus comprising:
an image formation unit that forms an unfixed image on a recording material; and
the fixing device according to claim 4 that fixes, onto the recording material, the unfixed image that is formed by the image formation unit.

14. An image forming apparatus comprising:
an image formation unit that forms an unfixed image on a recording material; and
the fixing device according to claim 5 that fixes, onto the recording material, the unfixed image that is formed by the image formation unit.

15. An image forming apparatus comprising:
an image formation unit that forms an unfixed image on a recording material; and
the fixing device according to claim 6 that fixes, onto the recording material, the unfixed image that is formed by the image formation unit.

16. An image forming apparatus comprising:
an image formation unit that forms an unfixed image on a recording material; and
the fixing device according to claim 7 that fixes, onto the recording material, the unfixed image that is formed by the image formation unit.

17. An image forming apparatus comprising:
an image formation unit that forms an unfixed image on a recording material; and
the fixing device according to claim 8 that fixes, onto the recording material, the unfixed image that is formed by the image formation unit.

18. An image forming apparatus comprising:
an image formation unit that forms an unfixed image on a recording material; and
the fixing device according to claim 9 that fixes, onto the recording material, the unfixed image that is formed by the image formation unit.
